(19) United States
(12) Patent Application Publication
(10) Pub. No.: US 2012/0060999 A1
(43) Pub. Date: Mar. 15, 2012

(54) REMOVABLE TOP BLANKET

(76) Inventors: Yael Kowal-Blau, Givalaim (IL); Yossi Albert, Petach Tikva (IL)

(21) Appl. No.: 13/259,787

(22) PCT Filed: Feb. 23, 2010
(86) PCT No.: PCT/US10/25041

§ 371 Date: Sep. 23, 2011

(51) Int. Cl. B32B 37/00; C09J 5/10; G03G 15/01

(52) U.S. Cl. 156/64; 156/306.6; 399/302

(57) ABSTRACT

A removable top blanket usable with a main blanket body of an intermediate transfer member of an image forming apparatus includes a continuous soft layer, a release layer disposed on an upper surface of the continuous soft layer, a removable top liner removably disposed on the release layer, the removable top liner having a support state in which the removable top liner is configured to support the release layer and an exposure state in which the removable top liner is configured to expose the release layer, an adhesion layer disposed on a lower surface of the continuous soft layer, the adhesion layer configured to at least adhere to the lower surface of the continuous soft layer, and a removable bottom liner removably disposed on the adhesion layer, the removable bottom liner having a protective state in which the removable bottom liner is configured to protect the continuous soft layer and an uncover state in which the removable bottom liner is configured to uncover the adhesion layer.

### BACKGROUND

Image forming apparatuses, such as a liquid electrostatic printing apparatuses, include image transfer blankets that receive images formed by the image forming apparatuses and transfer the images onto substrates such as print media. The image transfer blankets have a limited lifespan. Specifically, the outer layers of the image transfer blanket develop permanent damage that, over time, adversely affect print quality. Accordingly, image transfer blankets are normally replaced periodically.

### BRIEF DESCRIPTION OF THE DRAWINGS

Exemplary non-limiting embodiments of the present general inventive concept are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 is a schematic view illustrating an image forming apparatus including an image forming blanket according to an exemplary embodiment of the present general inventive concept.

FIGS. 2A and 2B are side views illustrating a removable top blanket usable with a main blanket body of an intermediate transfer member of an image forming apparatus in various states according to an exemplary embodiment of the present general inventive concept.

FIG. 3 is a flowchart illustrating a method of manufacturing a removable top blanket usable with a main blanket body of an intermediate transfer member of an image forming apparatus according to an exemplary embodiment of the present general inventive concept.

### DETAILED DESCRIPTION

In the following detailed description, reference is made to the accompanying drawings which form a part hereof, and in which is depicted by way of illustration specific embodiments in which the general inventive concept may be practiced. It is to be understood that other embodiments may be utilized and structural or logical changes may be made without departing from the scope of the present general inventive concept. The following detailed description, therefore, is not to be taken in a limiting sense, and the scope of the present general inventive concept is defined by the appended claims.

Several types of conventional image transfer blankets are used in image forming apparatuses. In one type, the entire image transfer blanket would need to be periodically replaced. In another type, a portion of the image transfer blanket can be replaced such as a removable top blanket independent of the rest of the image transfer blanket. In the case of the former type, the entire image transfer blanket used in an image forming apparatus is normally replaced when the useful life of any part of the image transfer blanket expires. Even though, the outer layers of the image transfer blanket expire well before the inner layers of the image transfer blanket. In the case of the latter type, a removable top blanket include outer layers of the image forming blanket can be replaced independent of the main blanket body. For example, the removable top blanket may be attached to and detached from a main blanket body of the image transfer blanket.

Removable top blankets may include a rigid layer such as a hard layer to structurally support the flexible outer layers thereof. The rigid layer becomes part of the image transfer blanket after installation of the removable top blanket to the main blanket body. The rigidity introduced by the rigid layer of the removable top blanket to the image transfer blanket, however, may adversely impact mechanical properties and conformability of the image transfer blanket. For example, the aforementioned removable top blanket may have an increased likelihood to incur dents, and difficulty conforming to the surface of a rough substrate. Thus, print quality may be reduced. Accordingly, in the present general inventive concept, a removable top blanket includes a removable top and bottom liner rather than a permanent rigid layer. Thus, rigidity is not introduced to the image transfer blanket when the removable top blanket of the present general inventive concept is joined with the main blanket body of the image transfer blanket. Accordingly, the mechanical properties of the image transfer blanket may be preserved.

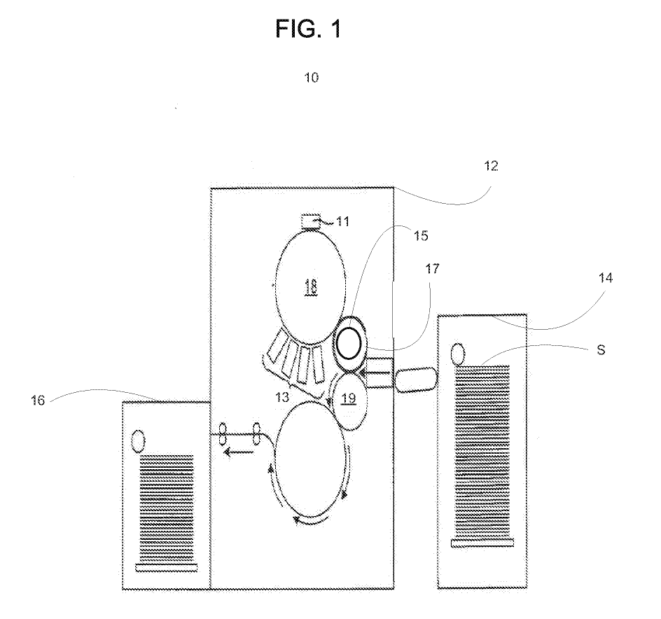

FIG. 1A is a schematic view of an embodiment of an image forming apparatus including an image forming blanket according to an exemplary embodiment of the present general inventive concept. Referring to FIG. 1, an image forming apparatus 10 includes a print unit 12 that receives a substrate S such as a print media from an input unit 14 and outputs the substrate S to an output unit 16. The print unit 12 includes a photo imaging member 18 that defines an outer surface on which images can be formed. For example, the outer surface can be charged with a suitable charger (not illustrated), such as a charge roller, and portions of the outer surface that correspond to features of the image can be selectively discharged by a laser writing unit 11 to form an electrostatic image on the outer surface. Ink, or pigment contained in the ink, can then be applied to the electrostatic image with ink development units 13 such as binary ink developers to form an ink image on the outer surface.

The ink image formed on the outer surface of the photo imaging member 18 is transferred to an intermediate member 15, which includes an image transfer blanket 17 that overlies an outer surface of the intermediate member 15. More particularly, the image transfer blanket 17 is securely attached to the outer surface of the intermediate member 15. The intermediate member 15 is configured to receive the ink image from the photo imaging member 18, heat the image, and transfer the image to the substrate S. During the transfer from the intermediate member 15 to the substrate S, the substrate S is pinched between the intermediate member 15 and an impression member 19. The repeated printing over time wears the outer layers of the image transfer blanket 17 of the intermediate member 15. In some cases, even inner layers become damaged as well, through permanent deformations. Once the ink image has been transferred to the substrate S, the substrate S can be transported to the output unit 16.

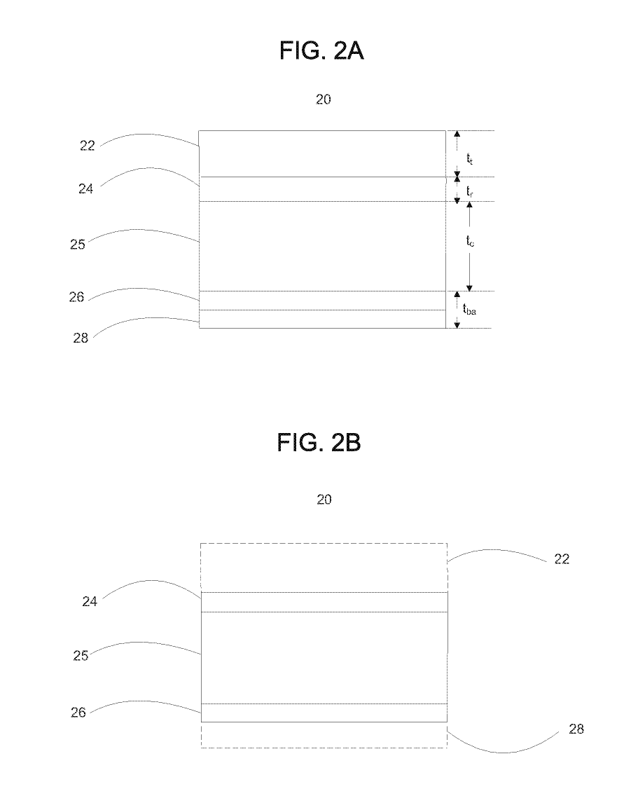

FIGS. 2A and 2B are side views illustrating a removable top blanket usable with a main blanket body of an intermediate transfer member of an image forming apparatus in various states according to an exemplary embodiment of the present general inventive concept. FIG. 2A illustrates the removable top blanket 20 having a removable top liner 22 in a support state and a removable bottom liner 28 in a protective state. FIG. 2B illustrates the removable top blanket 20 in which the removable top liner 22 is in an exposure state and the removable bottom liner 28 is in the uncover state. As illustrated in FIG. 2A, in the present example, the removable top blanket 20 includes a release layer 24, an adhesion layer 26, a continuous soft layer 25 disposed between the release layer 24 and the adhesion layer 26, a removable top liner 22 disposed on an upper surface of the release layer 24, and the removable bottom layer 28 disposed on a lower surface of the adhesion layer 26. The main blanket body (not illustrated), that is old and well-known, may include multiple layers such as a conductive layer, a sponge layer, and a fabric layer. The main blanket body is disposed on the intermediate transfer member 15 (FIG. 1) such as a drum. For example, the main body adhesion layer may adhere to the intermediate transfer member 15, or may be attached using clamps.

Referring to FIGS. 1 and 2A, the release layer 24 is configured to receive an image from an imaging surface of the image forming apparatus 10 and transfer the image from the release layer 24 to the substrate S. By way of example, the release layer 24 may include a layer of silicone and have a thickness tᵣ in a range of approximately 5 to 10 microns. The continuous soft layer 25 is configured to conform to the substrate S onto which the image is transferred. By way of example, the continuous soft layer 25 may include a layer of acrylic material and have a thickness t_{c} in a range of 80 to 180 microns, such as approximately 100 microns.

In the present example, the removable top liner 22 includes a support state as illustrated in FIG. 2A and an exposure state as illustrated in FIG. 2B. In the support state, the removable top liner 22 is configured to support the release layer 24. For example, in the support state, the removable top liner 22 is disposed on the release layer 24 and adheres to the release layer 24 providing structure to the flexible release layer 24 and continuous soft layer 25 as illustrated in FIG. 2A. In an example, the removable top liner 22 is also configured to protect the release layer 24 when the removable top liner 22 is in the support state. Thus, the removable top liner 22, in the support state, allows the removable top blanket 20 to be properly handled and/or transported. In an example, in the support state, the removable top liner 22 may adhere to the release layer 24 through a primer. In the present example, adherence of the removable top liner 22 to the release layer 24 has a low peel to allow the removable top liner 22 to be removed with relative ease and prevent residue from remaining on the release layer 24. For example, the peel may be 50 grams/cm at 60° C.

In the exposure state, the removable top liner 22 is not disposed on the release layer 24 and is configured to expose the release layer 24 as illustrated in FIG. 2B. Thus, in the exposure state, the release layer 24 can receive the image from the imaging surface of the image forming apparatus 10 (FIG. 1) and transfer the image from the release layer 24 to the substrate S. In the present example, the removable top liner 22 has a thickness tₜ in a range of 60 to 100 microns. In other examples, the range of thickness tₜ of the removable top liner 22 may be less than 60 microns or greater than 100 microns. In the present example, the removable top liner 22 may include, but not be limited to, polyethylene terephthalate (PET).

In the present example, an adhesion layer 26 is disposed on a lower surface of the continuous soft layer 25 and is configured to at least adhere to the lower surface of the continuous soft layer 25 as illustrated in FIGS. 2A and 2B. In the present example, adherence of the adhesion layer 26 to the continuous soft layer 25 may have a peel at least five times greater than a peel of adherence of the adhesion layer 26 to the main body blanket in the uncover state of the removable bottom liner 28. The peel of the adhesion layer 26 to the main blanket body is higher than the peel of the removable top liner 22 to the release layer 24. For example, the peel of the adhesion layer 26 to the main body blanket may be 100 gram/centimeter. The shear of the adhesion layer 26 to the continuous soft layer 25 may be greater than 5 kg/cm² up to 120° C. The peel of the adhesion layer 26 to the main blanket body may be higher than the peel of the removable top liner 22 to the release layer 24. For example, the shear of the adhesion layer 26 to the main body blanket and the continuous soft layer 25 may be greater than 5 kg/cm² up to 120° C.

Referring to FIG. 2A, the removable bottom liner 28 is removably disposed on the adhesion layer 26 and includes a protective state and an uncover state. In the present example, the removable bottom liner 28 and the adhesion layer 26 are combined prior to being joined to the continuous soft layer 25. In the protective state, the removable bottom liner 28 is disposed on the adhesion layer 26 and is configured to protect the continuous soft layer 25 as illustrated in FIG. 2A. In the uncover state, the removable bottom liner 28 is not disposed on the adhesion layer 26 and is configured to uncover the adhesion layer 26 as illustrated in FIG. 2B. In an example, in the uncover state, the adhesion layer 26 is configured to adhere to the main blanket body. In the present example, a combined thickness t_{ba} of the removable bottom liner 28 and the adhesion layer 26 is no greater than 30 microns. In other examples, the combined thickness t_{ba} of the removable bottom liner 28 and the adhesion layer 26 is greater than 30 microns. In the present example, the removable bottom liner 28 may include, but not be limited to siliconized PET.

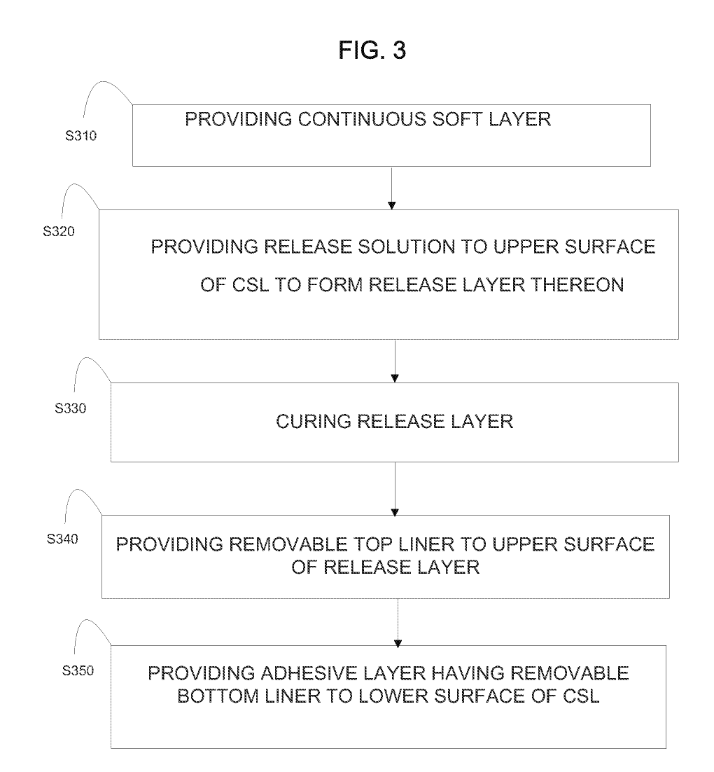

FIG. 3 is a flowchart illustrating a method of manufacturing a removable top blanket usable with a main blanket body of an intermediate transfer member of an image forming apparatus according to an exemplary embodiment of the present general inventive concept. Referring to FIGS. 2A and 4, in operation S310, a continuous soft layer is provided. For example, a continuous soft layer may be supplied in the form of a supply roll. In operation S320, a release solution is provided to an upper surface of the continuous soft layer to form a release layer thereon. For example, a release solution may be deposited on the upper surface of the continuous soft layer. In operation S330, the release layer is cured. For example, the curing of the release layer may include heating the release layer. In one example, heating may be performed by an oven, for example, having a predetermined temperature. In another example, the heating may be performed by several ovens, for example, each having a different predetermined temperature. In other examples, the heating may be performed by one or more ovens and a heating roller. In operation S340, a removable top liner is provided to an upper surface of the release layer. For example, the removable top liner may be fed from a supply roll to the upper surface of the release layer. In operation S350, an adhesion layer having a removable bottom liner is provided to a lower surface of the continuous soft layer in which the adhesion layer contacts the continuous soft layer. For example, the adhesion layer having a removable bottom liner may be fed from a supply roll to a lower surface of the continuous soft layer. In another example, each of the adhesion layer and the removable bottom liner may be independently provided to the continuous soft layer.

In an example, the method of manufacturing the removable top blanket may further include providing a primer to the continuous soft layer prior to providing the release solution to the upper surface of the continuous soft layer to allow adhesion between the continuous soft layer and the release layer. For example, the primer may be the form of a solution and deposited on the upper surface of the continuous soft layer. The method may also include inspecting the removable top blanket and cutting the removable top blanket to a predetermined size. The removable top blanket may be inspected for defects such as raw material defects, coating defects, etc. Also, in the present example, cutting the removable top blanket may include cutting both a width and a length of the removable top blanket.

The present general inventive concept has been described using non-limiting detailed descriptions of example embodiments thereof that are provided by way of example and are not intended to limit the scope of the general inventive concept. It should be understood that features and/or operations described with respect to one embodiment may be used with other embodiments and that not all embodiments of the general inventive concept have all of the features and/or operations illustrated in a particular figure or described with respect to one of the embodiments. Variations of embodiments described will occur to persons of the art. Furthermore, the terms “comprise,” “include,” “have” and their conjugates, shad mean, when used in the disclosure and/or claims, “including but not necessarily limited to.”

It is noted that some of the above described embodiments may describe examples contemplated by the inventors and therefore may include structure, acts or details of structures and acts that may not be essential to the general inventive concept and which are described as examples. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. A removable top blanket usable with a main blanket body of an intermediate transfer member of an image forming apparatus, the removable top blanket comprising:
a continuous soft layer;
a release layer disposed on an upper surface of the continuous soft layer;
a removable top liner removably disposed on the release layer, the removable top liner having a support state in which the removable top liner is configured to support the release layer and an exposure state in which the removable top liner is configured to expose the release layer;
an adhesion layer disposed on a lower surface of the continuous soft layer, the adhesion layer configured to at least adhere to the lower surface of the continuous soft layer; and
a removable bottom liner removably disposed on the adhesion layer, the removable bottom liner having a protective state in which the removable bottom liner is configured to protect the continuous soft layer and an uncover state in which the removable bottom liner is configured to uncover the adhesion layer.

2. The removable top blanket according to claim 1, wherein the removable top liner is disposed on the release layer when the removable top liner is in the support state.

3. The removable top blanket according to claim 1, wherein the removable top liner is not disposed on the release layer when the removable top liner is in the exposure state.

4. The removable top blanket according to claim 1, wherein the removable top liner has a thickness in a range of 60 to 100 microns.

5. The removable top blanket according to claim 4, wherein the removable top liner is configured to protect the release layer when the removable top liner is in the support state.

6. The removable top blanket according to claim 2, wherein the removable bottom liner is disposed on the adhesion layer when the removable bottom liner is in the protective state.

7. The removable top blanket according to claim 3, wherein the removable bottom liner is not disposed on the adhesion layer when the removable bottom liner is in the uncover state.

8. The removable top blanket according to claim 1, wherein the removable top liner and the release layer adhere to each other through a primer.

9. The removable top blanket according to claim 1, wherein the adhesion layer is configured to adhere to the main blanket body when the removable bottom liner is in the uncover state.

10. The removable top blanket according to claim 1, wherein a combined thickness of the removable bottom liner and the adhesion layer is no greater than 30 microns.

11. The removable top blanket according to claim 10, wherein the release layer is configured to receive an image from an imaging surface of the image forming apparatus and transfer the image from the release layer to a substrate.

12. The removable top blanket according to claim 11, wherein the continuous soft layer is configured to conform to the substrate onto which the image is transferred.

13. A method of manufacturing a removable top blanket usable with a main blanket body of an intermediate transfer member of an image forming apparatus, the method comprising:
providing a continuous soft layer;
providing a release solution to an upper surface of the continuous soft layer to form a release layer thereon;
curing the release layer;
providing a removable top liner to an upper surface of the release layer; and
providing an adhesion layer having a removable bottom liner to a lower surface of the continuous soft layer.

14. The method according to claim 13, further comprising:
providing a primer to the continuous soft layer prior to the providing the release solution to the upper surface of the continuous soft layer to allow adhesion between the continuous soft layer and the release layer;
inspecting the removable top blanket; and
cutting the removable top blanket to a predetermined size.

15. The method according to claim 13, wherein the curing the release layer comprises:
heating the release layer by at least one of a plurality of ovens and a heating roller.
